(19) United States
(12) Patent Application Publication
(10) Pub. No.: US 2007/0017576 A1
(43) Pub. Date: Jan. 25, 2007

(54) Inflatable sewage line backflow prevention devices

(76) Inventors: Glenn Mack McHinnis, Lutz, FL (US); John Franklin Coyne, Mechanicsburg, PA (US)

Correspondence Address: Glenn McHinnis, 4902 Mirabella Place, Lutz, FL, 33558, US

(21) Appl. No.: 11/185,034

(22) Filed: Jul. 20, 2005

(51) Int. Cl. F16L 55/24

(52) U.S. Cl. 137/247.51

(57) ABSTRACT

The Federal Emergency Management Agency reports that an average of over 35,000 homes in designated flood areas file flood claims averaging in excess of $18,000. Twenty-five percent of all homeowner flood insurance claims come from areas that were not considered to be high risk. Homes generally not at risk of flooding can be seriously impacted by other failures such as loss of power to sewer lift stations, which results in a sewer system backflow into homes. Existing devices such as sewer backflow valves are installed on some homes. In many instances these devices fail due to obstructions and wear. The homeowner has no viable method to test such devices and won't be able to react to failures in time to save their home and contents. The Inflatable Sewage Line Backflow Prevention Devices described herein can be rapidly deployed in a multitude of embodiments to block sewer backup in emergency situations.

### BACKGROUND OF THE INVENTION

1. Technical Field of the Invention

The present invention describes devices and plumbing components designed to stop sanitary and storm sewer backups from entering a building structure via the sewer system by blocking the sewer lateral line or bypassing the home sewer system.

2. Description of Related Art

Sanitary sewer flooding due to backups or backflow into a structure can result in severe water damage, noxious odors, permanent staining of contents and structure. In addition, sewage backups represent a severe health threat as the contents of a sewer system are extremely contaminated from sources including bacteria and chemical factors.

Sewer flooding because of a backflow condition can be induced for several reasons.

A common backflow cause results from overflow from storm sewers into sanitary sewers. This can be caused by excessive rainfall or flooding due to watercourse overflow, tidal surges or manmade causes such as ruptured water mains. Sewer system backflow can also be induced by systemic failures including but not limited to; sewer lift station failures or power outages, inadequate sewer system or sewer line capacities, mechanical failures, construction accident, ground water intrusion and system operational procedural errors.

There exists certain devices that may be utilized to prevent sewer system backflow from entering a building thru the lateral line. Many commercial buildings have manually or electrically operated sewer system shut off valves. These valves when transferred to the closed position physically block the flow of sewage into and out of the building. A licensed contractor must install sewer system shut off valves.

Sewage backflow valves utilize one of a multitude of flapper type check valves to allow sewage out-flow from a building but block backflow into the building. Sewer bypass valves permit sewage to exit a sewer system when the sewage reaches a predetermined physical level. Sewage backflow valves must be installed and maintained by licensed contractors. The nature of the flapper valve assembly can cause obstructions to lodge in the valve area and contribute to backups within the sewer line at that point. In addition, any obstruction or mechanical failure of the flapper valve causes the assembly to fail and allow sewage backflow into the structure. There is no viable method for a homeowner to verify the proper operation of a backflow valve and ensure the structure is protected from sewage backflow.

There exists a need within the art for a homeowner installable and removable device or devices that may be temporarily used to block sewer system backflow into their homes in times of emergency such as hurricane surges, sewer system failures lift station electrical failures, and other causes. This need exists for sewer systems with central access or clean out points whereby one device may be used to ensure blocking of the entire system. In addition, there exists a need within the art for use of multiple devices to ensure sewage backflow protection when there is no single access or cleanout point.

### SUMMARY OF THE INVENTION

Inflatable Sewage Line Backflow Prevention Devices are inflatable bladders constructed from neoprene or a similar rubber material. The bladders are inserted into the sewage system of a structure such as a house and inflated in order to block backflow into the entire system or portions thereof. An Inflatable Sewage Line Backflow Device may also be used to cause sewage backflow to bypass the homes sewer system and vent externally.

The first preferred embodiment of an Inflatable Sewage Line Backflow Prevention Device is to insert a device into a central access or cleanout port of the sewer system of a structure. The use of this embodiment includes guiding the deflated bladder by use of the semi rigid Bladder Inflation Tube into a position where the system can be blocked or bypassed. The system blocking is accomplished by inserting the Inflatable Bladder into the lateral sewer line side of the access tee, which connects the sewer main to the home sewer system and inflating the bladder with air to a state whereby the pipe is plugged and the bladder is lodged within the pipe.

A second preferred embodiment of an Inflatable Sewer Line Backflow Prevention Device is to insert a device into a central access or cleanout port of the sewer system that is external to the structure. The use of this embodiment includes guiding the deflated bladder by use of the semi rigid Bladder Inflation Tube into a position where the system flow can be bypassed from entering the structure. Bypassing is accomplished by accomplished by inserting the Inflatable Bladder into the home sewer mail line side of the access tee and inflating the bladder with air to a state whereby the sewage backflow if blocked from entering the home sewer system and allowed to exit the sewer lateral thru the cleanout tee. This embodiment does not pressurize the sewer lateral line and avoids placing any additional pressure to any portion of the home sewer system.

An alternative embodiment consists of blocking some or all drain connections to a structures sewer system with a Single Drain Inflatable Bladder. This embodiment is utilized in instances where there is no central access or cleanout port or trap installed in the structures sewage system. It may also be employed when the access port cannot be located. This embodiment utilizes smaller bladders which are specially shaped to penetrate thru small diameter pipes and their P and S traps so that the bladder can be positioned within the sewer system pipe that is connected to the discharge side of the P or S trap.

An additional claim simplifies the use of this embodiment. The claim provides for P and S trap fixtures having removable access plugs that allow insertion of the Inflatable bladder directly into the structures sewer system pipe without having to thread the Inflatable Bladder and its' inflation tube thru small drain apertures and P or S traps.

### BRIEF DESCRIPTION OF THE DRAWINGS

FIG. 1 is a side view of the basic Inflatable Sewage Line Backflow Prevention Device;

FIG. 2 is a side view of a sewer cleanout tee assembly;

FIG. 2A is a side view of an un-inflated basic Inflatable Sewage Line Backflow Prevention Device inserted within a sewer cleanout tee assembly;

FIG. 3 is a side view of an inflated basic Inflatable Sewage Line Backflow Prevention Device inserted within a sewer cleanout tee assembly;

FIG. 3A is a side view of an inflated Basic Inflatable Sewage Line Backflow Prevention Device inserted within a sewer cleanout tee assembly in the sewer bypass position;

FIG. 3B is a side view of an inflated Basic Inflatable Sewage Line Backflow Prevention Device inserted within a sewer cleanout tee assembly in the sewer blocking position;

FIG. 4 is a cross section view of 2 Single Drain Inflatable Sewage Backflow Prevention Devices bladder designs;

FIG. 5 illustrates how a Single Drain Inflatable Sewage Backflow Prevention Device can be placed using a sink drain;

FIG. 6 illustrates how a Single Drain Inflatable Sewage Backflow Prevention Device can be placed directly into a drainpipe bypassing the P-trap;

FIG. 7 is a side and end view of a P trap exit pipe with an Inflatable Sewage Backflow Prevention Device Access Port;

FIG. 8 is a cross section view of a P trap exit pipe with an Inflatable Sewage Backflow Prevention Device Access Port;

FIG. 9 is a cross section of a sink drain with a P trap exit pipe equipped with an Inflatable Sewage Backflow Prevention Device Access Port with an inserted single drain Inflatable Sewage Backflow Prevention Device;

FIG. 10 is a cross section of sink drain with an S trap exit pipe equipped with an Inflatable Sewage Backflow Device Access Port with an inserted single drain Inflatable Sewage Backflow Prevention Device.

FIG. 11 is a side view of an interior sewer cleanout;

FIG. 11A is a side view of an interior sewer cleanout with an attached Permanently Installed Inflatable Sewage Backflow Prevention Device;

FIG. 11B is a side view of an interior sewer cleanout with an attached Permanently Installed Inflatable Sewage Backflow Prevention Device showing the deflated bladder in the retracted position;

FIG. 11C is a side view of an interior sewer cleanout with an attached Permanently Installed Inflatable Sewage Backflow Prevention Device showing the inflated bladder in the extended position;

### DETAILED DESCRIPTION OF THE DRAWINGS

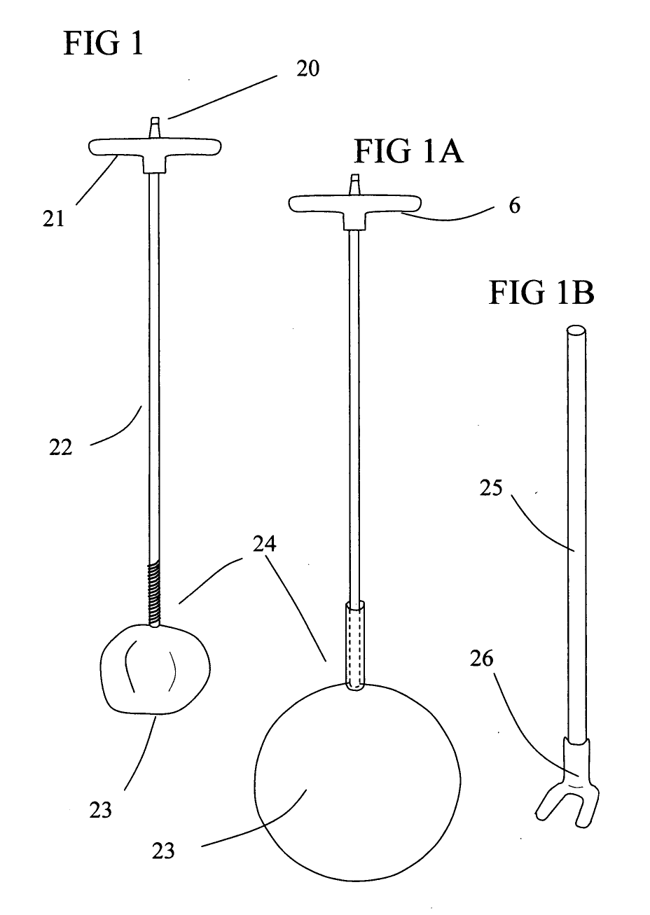

FIG. 1 illustrates the Basic Inflatable Sewage Line Backflow Prevention Device in the deflated state. The device consists of a bladder (23), a semi-rigid inflation and insertion shaft (22), a handle and retainer (21) and a Schrader inflation valve (20). A variation of this embodiment would provide additional stiffening capabilities to the portion of the semi-rigid inflation and insertion shaft (22) in the region (24) where the shaft joins the bladder (23). The additional stiffening better enables pre-shaping of the insertion tube when it is desired to insert the bladder (23) into a pipe branch by altering the path of the shaft as it is inserted. Additional stiffening can be provided in a multitude of methods including spiral-wrapping, encapsulation with a stiffer material or adding a stiffening rod.

FIG. 1A illustrates the Basic Inflatable Sewage Line Backflow Prevention Device in the inflated stage. The bladder (23) is inflated by pumping air thru the attached Schrader inflation valve (20). Air may be supplied in a multitude of ways including a compressed air cylinder, tower hand air pumps, foot powered air pumps, mechanical air compressors or other pressurized air sources. The Basic Inflatable Sewage Line Backflow Prevention Device is a low-pressure device and only requires a small volume of air for inflation. A multitude of sizes may be required to fit the multitude of pipe diameters used for sewage lines. The Insertion Handle and Retainer Device (6), is used to guide the Basic Inflatable Sewage Line Backflow Prevention Device in and out of the cleanout opening. The width of the Insertion Handle and Retainer Device (6) also keeps the device from being lost down the drain system as its width exceeds the diameter of the opening.

Persons using Basic Inflatable Sewage Line Backflow Prevention Devices will always be instructed to leak test the device prior to use by inflating the device to a stated pressure or diameter, immersing the device in water and observing for the presence of escaping air bubbles.

FIG. 1B illustrates an additional embodiment that may be utilized to “steer” or guide the Basic Inflatable Sewage Line Backflow Prevention Device when it must be moved or relocated after insertion within a cleanout Trap. It can also be used to push the Basic Inflatable Sewage Line Backflow Prevention Device thru a sewer pipe prior to inflation. The embodiment consists of a shaft (25) and a Basic Inflatable Sewage Line Backflow Prevention Device guide (26) that fits around the Basic Inflatable Sewage Line Backflow Prevention Device semi-rigid inflation and insertion shaft (22).

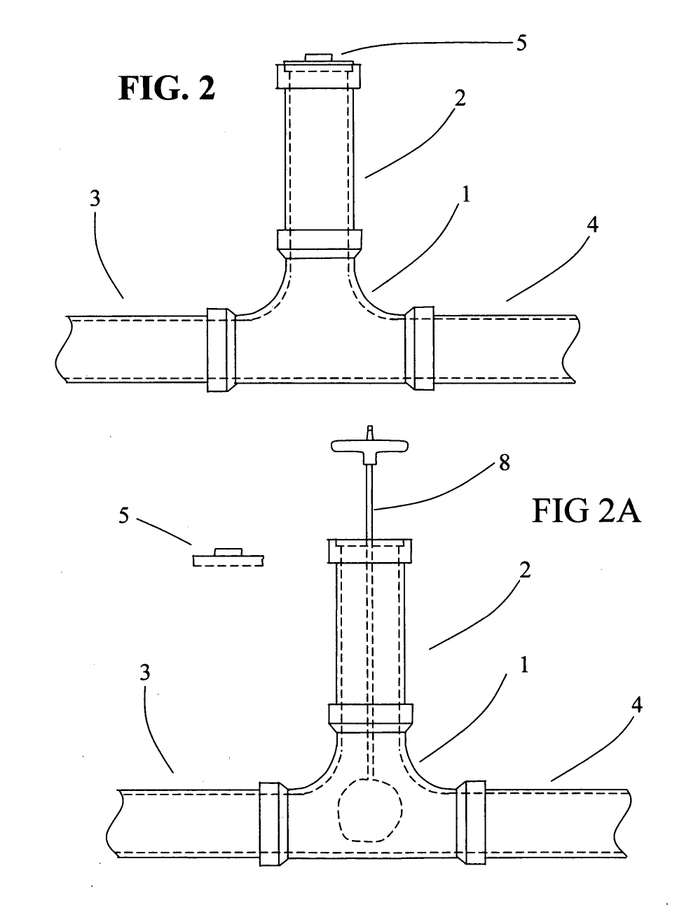

FIG. 2 is a side view of a commonly used sewer cleanout trap or T trap. Most residential sewer systems are equipped with one or a plurality of cleanout traps. Cleanout traps are inserted within the lateral sewer lines that are used to connect the residential sewer output line to the sewer main line. A cleanout trap is comprised of a Tee fitting (1), a vertical extension (2), a threaded cap (5), a horizontal connection to the residential sewer system (3), and a horizontal connection to the lateral sewer line (4) which connects to the sewer main. During normal operation, household sinks, toilets, showers, bathtubs, washing machines, garbage disposals and other appliances discharge into the residential sewer system, which terminates at the lowest point. Waste and water is discharged into the sewer system path from this point as it enters the lateral sewer line (4).

FIG. 2A Illustrates the insertion of the Basic Inflatable Sewage Backflow Prevention Device (8) into the sewer cleanout trap. This insertion process is common to the 3 embodiments of the use of the Basic Inflatable Sewage Backflow Prevention Device.

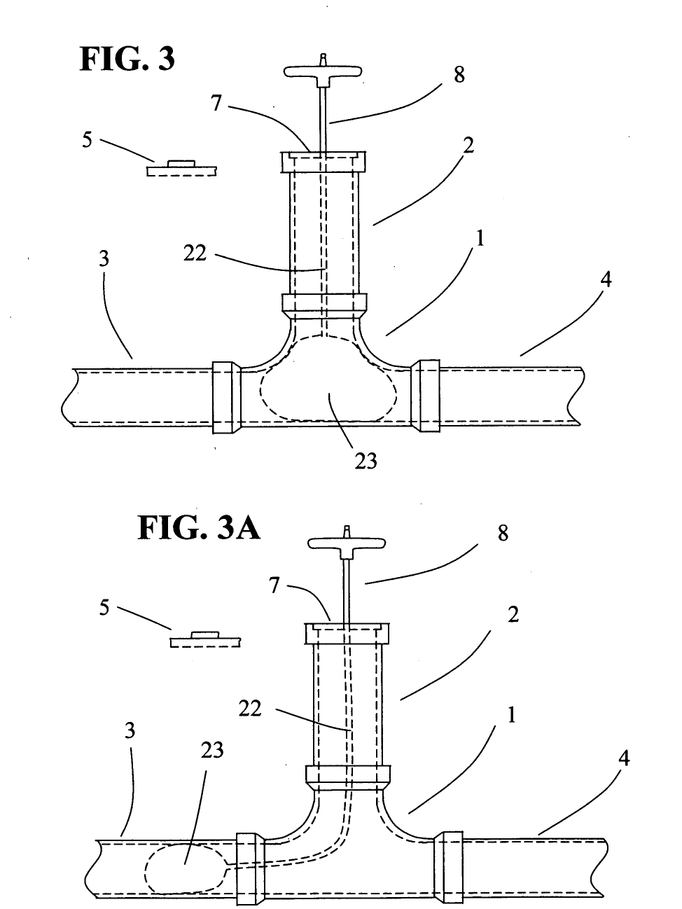

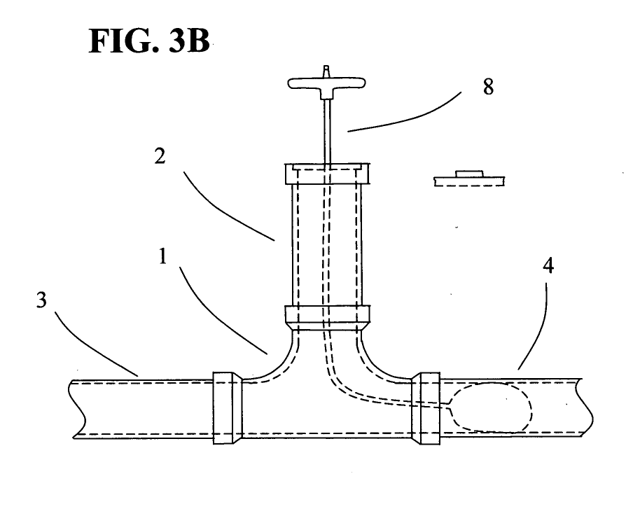

FIG. 3 Illustrates the simplest implementation of the Basic Inflatable Sewage Backflow Prevention Device (8). This embodiment is the easiest to perform and blocks the flow of solids and liquids thru all 3 openings of the cleanout Tee fitting.

The installation process begins by unscrewing the cleanout trap cover (5), ensuring that the semi-rigid inflation shaft (22) is straight and that the bladder (23) is deflated. The device is then inserted vertically into the cleanout trap cover opening (7) opening and allowed to descend until the bladder (23) is resting upon the bottom of the cleanout Tee fitting (1). The bladder (23) is then inflated to a prescribed pressure by use of air sources as listed in the description for FIG. 1. This embodiment blocks any and all flow of solids and liquids thru the Cleanout Tee fitting (1). Thus, this embodiment blocks any backflow of liquids or solids from the sewer lateral line (4) into the cleanout Tee fitting (1). The flow of liquids and solids from the residential sewer system (2) is also isolated and blocked from entering the cleanout Tee (1). Above ground floodwater that rises above the level of the cleanout trap cover opening (7) is also prevented from flowing into either the sewer lateral line (4) or the residential sewer system connection line (2).

FIG. 3A Illustrates an alternate embodiment of the Basic Inflatable Sewage Backflow Prevention Device (8). This embodiment isolates the residential sewer system from the sewer lateral line (4). It does however allow the outflow of any sewage backflow to flow up the vertical extension (2). This implementation is favored because it protects the residence and does not place any additional pressure upon the sewer system. This embodiment is desirable for communities with marginal sewer systems that prohibit backflow blockage devices.

The installation process begins by unscrewing the cleanout trap cover (5), ensuring that the semi-rigid inflation shaft (22) is slightly bent near the point where the shaft and bladder (23) join and that the bladder (23) is deflated. The device is then inserted vertically into the cleanout trap cover opening (7) and allowed to descend until the bladder (23) is resting upon the bottom of the cleanout Tee fitting (1) with the bend in the semi-rigid insertion shaft (22) directed so that it enters the branch of the Tee fitting (1) that leads to the residential sewer connection (3). The bladder (23) is then inflated to a prescribed pressure by use of air sources as listed in the description for FIG. 1. This embodiment blocks any and all flow of solids and liquids thru the Cleanout Tee fitting (1) into the residential sewer system.

FIG. 3B Depicts an additional embodiment of the Basic Inflatable Sewage Backflow Prevention Device (8). This embodiment isolates the sewer lateral line (4) and prevents backflow into the cleanout Tee fitting (1),

The installation process begins by unscrewing the cleanout trap cover (5), ensuring that the semi-rigid inflation shaft (22) is slightly bent near the point where the shaft and bladder (23) join and that the bladder (23) is deflated. The device is then inserted vertically into the cleanout trap cover opening (7) and allowed to descend until the bladder (23) is resting upon the bottom of the cleanout Tee fitting (1) with the bend in the semi-rigid insertion shaft (22) directed so that it enters the branch of the Tee fitting (1) that leads to the sewer system lateral line (4). The bladder (23) is then inflated to a prescribed pressure by use of air sources as listed in the description for FIG. 1. This embodiment blocks any and all flow of solids and liquids into the Cleanout Tee fitting (1) and into the residential sewer system.

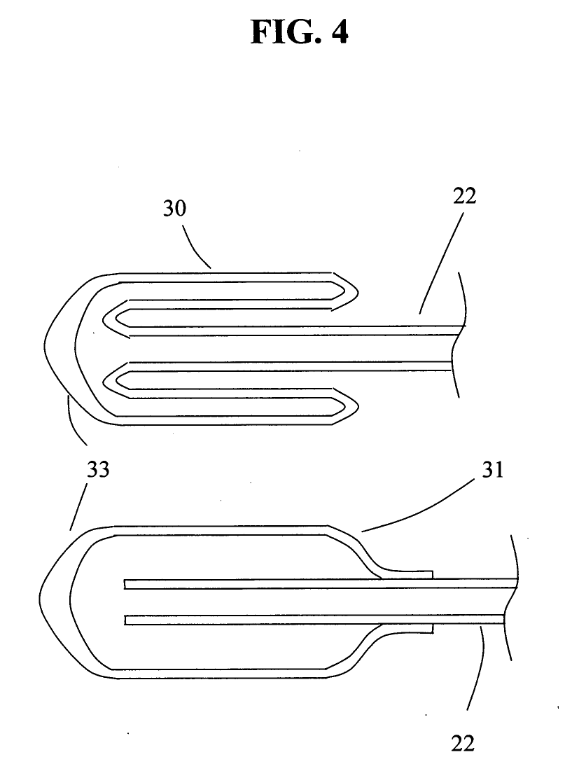

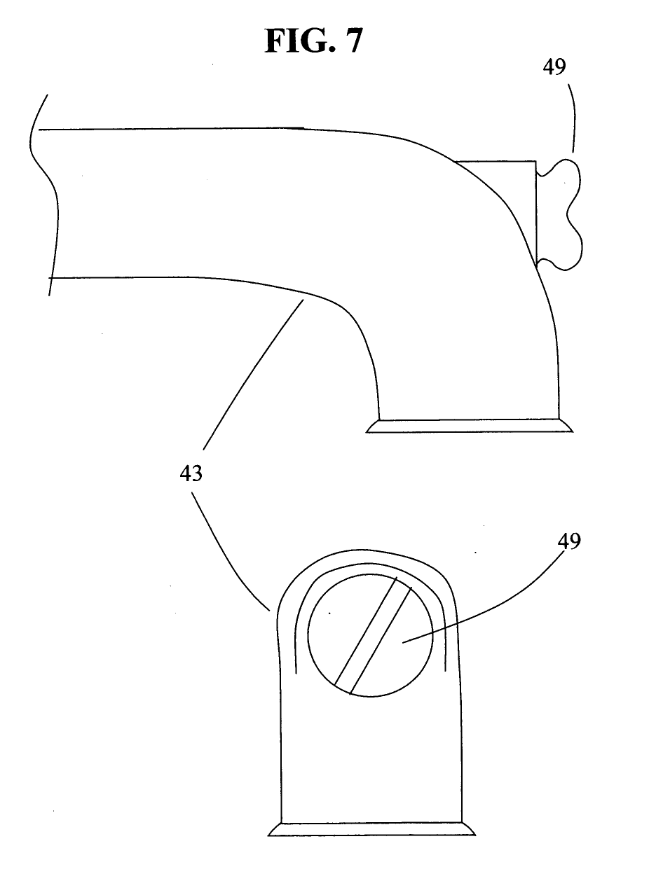

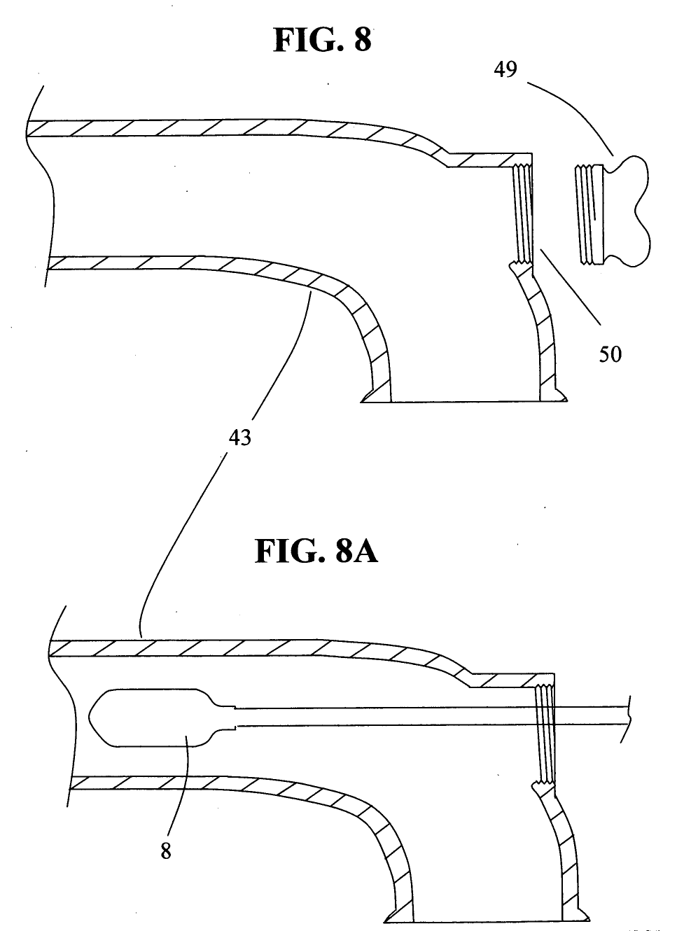

FIG. 4 Illustrates 2 designs for a Single Drain Inflatable Sewage Backflow Prevention Device bladder. These bladder styles (30 and 31) are used in place of the larger style bladder ((23) on FIG. 3B) for embodiments that are used to seal an individual drain within a residential sewer system. Single drain embodiments are used when the residential sewer system has no cleanout trap or when the owner cannot locate the cleanout trap. Single Drain Inflatable Sewage Backflow Prevention Devices are utilized in a multitude of procedures. The first method consists of inserting them directly into the sewer drainpipes thru the drain opening. The devices can also be inserted directly into the residential sewer drainpipe by removing the P or S-trap and inserting the device directly into the open end of the pipe itself. An additional invention claim represented in FIG. 7 and FIG. 8 allows an alternate means of bypassing the drain assembly without disconnecting the P or S-trap assemblies.

The Single Drain Inflatable Sewage Backflow Prevention Device bladders (30 and 31) are designed to be pushed thru the drainage path until they enter the sewer drainpipes where they are inflated. The design embodiments include substantially thicker rubber on the front or penetration surfaces (33). The thicker rubber will resist puncturing when it receives pressure from the end of the insertion tube and when it is pushed against drain surfaces when is installed.

Single Drain Inflatable Sewage Backflow Prevention Device bladders (30 and 31) may be used in every drain opening within a residence or they may be used selectively. A multi-story residence would typically only use Single Drain Inflatable Sewage Backflow Prevention Device bladders (30 and 31) for drains in the lower portions of the residence. There is no point in attempting to block sewage backflow that exceeds the design limitations of the devices and any circumstances that cause backflow of that magnitude are probably catastrophic in nature.

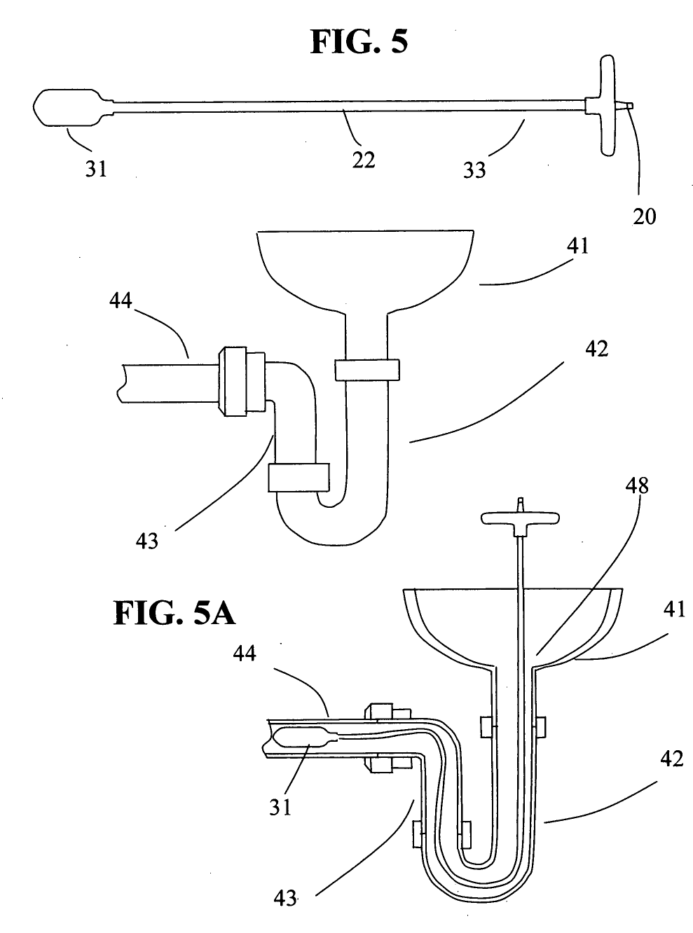

FIG. 5 illustrates a Single Drain Inflatable Sewage Backflow Prevention Device. The device is comprised of a bladder (31), an insertion shaft (22), an insertion handle and retention device (6) and a Schrader inflation valve (20). The Single Drain Inflatable Sewage Backflow Prevention Devices is similar to the Basic Single Drain Inflatable Sewage Backflow Prevention Device with the differences being a smaller bladder and the shape of the bladder.

Also included is a representative side view of a typical lavatory sink (41) a 2-piece P-trap (42 and 43) and the sewer drainpipe (44), which is actually a portion of the residential sewer system. There are several figures that illustrate single drain embodiments utilizing a 2-piece P-trap. All of these embodiments also apply to installations using S-traps. It should be emphasized that the typical P or S-trap in a modern house is constructed of thin wall plastic and could be easily fractured by inflating a Single Drain Inflatable Sewage Backflow Prevention Device bladder (31) within them. In addition, S and P-traps are not constructed to withstand any pressure. If the drain path was blocked such that the P or S-trap joints come under pressure they will probably leak. Therefore several embodiments will be claimed that allow insertion of the Single Drain Inflatable Sewage Backflow Prevention Devices' bladder (31) far enough into the drain path to ensure it is inflated within the more substantial sewer system drainpipe.

FIG. 5A Illustrates how a Single Drain Inflatable Sewage Backflow Prevention Device can be inserted thru the drain opening (48). This type of insertion is not always possible as it required the removal of any installed drain stopper in order to obtain enough clearance for insertion of the Single Drain Inflatable Sewage Backflow Prevention Device.

Instructions for implementing this embodiment include. Inflating the Single Drain Inflatable Sewage Backflow Prevention Devices' bladder (31) and placing the entire assembly under water to check for air leaks. The next step is to remove the drain stopper. After removal of the stopper the Single Drain Inflatable Sewage Backflow Prevention Device is inserted and pushed far enough into the drain path to ensure that the bladder (31) is located within the sewer system drainpipe (44). The bladder (31) is then inflated with air to the desired pressure.

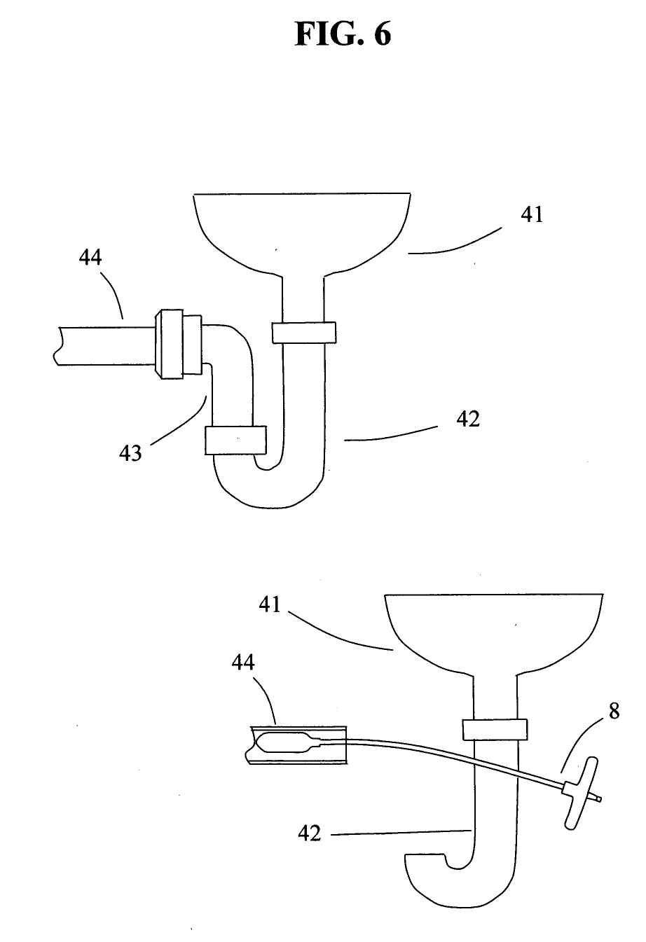

FIG. 6 illustrates an alternate embodiment of the Single Drain Inflatable Sewage Backflow Prevention Device. This embodiment is recommended when the homeowner is unable to remove the drain flap or cannot successfully thread the Single Drain Inflatable Sewage Backflow Prevention Device thru the drain path.

The owner would be instructed to remove or disconnect the back half of the S or P-trap assembly (43) and expose the open end of the sewer system drainpipe (44). The Inflatable Backflow Protection Device (8) would then be inserted. The bladder (31) is then inflated with air to the desired pressure.

FIG. 7 is a side view and an end view of the exit or back portion of a P-trap (43) that facilitates easy insertion of a Single Drain Inflatable Sewage Backflow Prevention Device without removing or unhooking the P-trap. This embodiment is used to replace the existing P-trap component. The device can be installed at any time and would remain permanently in place within the drain system. The device differs from the conventional P-trap component in that a removable threaded plug (49) has been added. The plug can be removed whenever it is necessary to insert a Single Drain Inflatable Sewage Backflow Prevention Device in order to protect against sewer backflow.

FIG. 8 is a cross sectional view of the modified P-trap component (43) showing the relationship between the access plug (48) and the threaded opening (50) of the modified P-trap component. This allows the insertion of an Inflatable Backflow Prevention Device (8).

FIG. 8A illustrates how a Single Drain Inflatable Sewage Backflow Prevention Device (8) is inserted into the modified P-trap component (43).

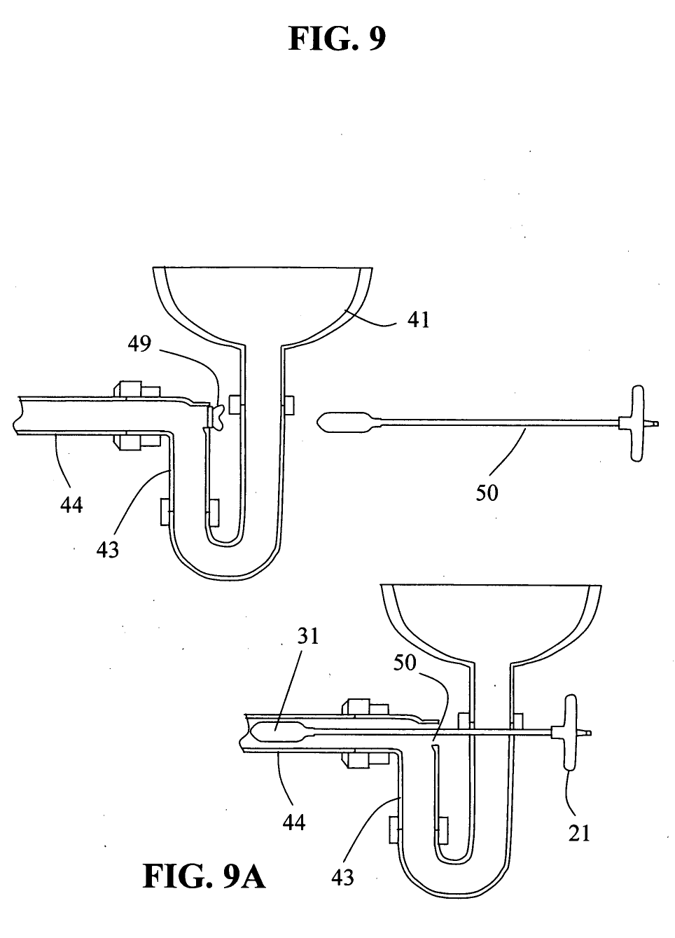

FIG. 9 is a cross section view of a modified P-trap (43) installed in a lavatory sink drain assembly. The access plug (49) is accessible and can be removed by accessing the plumbing area under the sink (41).

FIG. 9A is a cross section view of a lavatory drain system with a modified P-Trap fixture (43).

The procedure to block this fixture from sewage backflow would be to first remove the access plug (49). The plug design is such that it can be removed by hand or grasped with pliers or a wrench if required. After removing the access plug (49) the Single Drain Inflatable Sewage Backflow Prevention Device (8) can be inserted tiru the modified P-trap access opening (50). The Single Drain Inflatable Sewage Backflow Prevention Device (8) is inserted to a depth that ensures that the bladder (31) is within the sewer system drainpipe (44). The bladder (31) is then inflated by applying air thru the Schrader fitting (20).

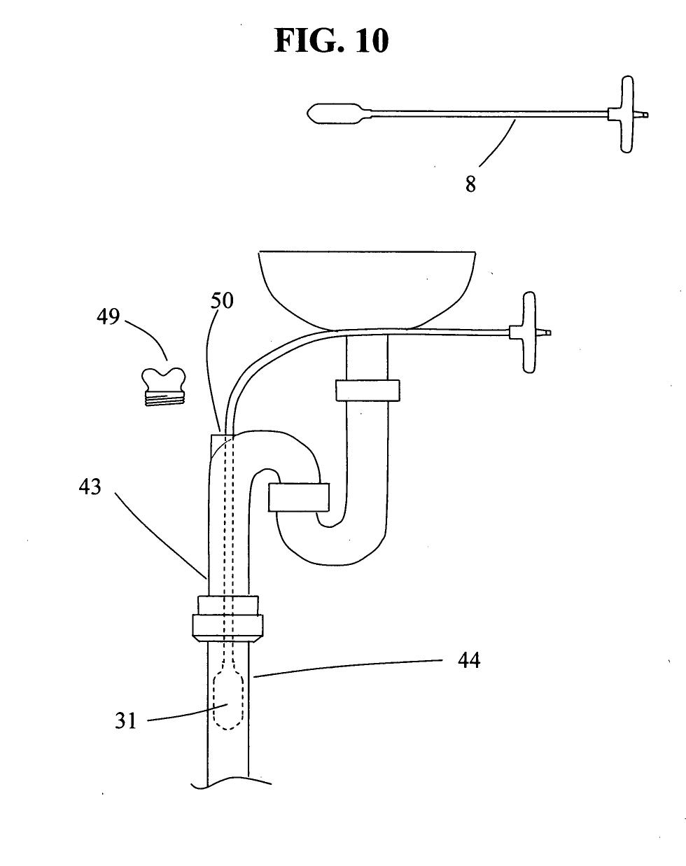

FIG. 10 is a side view of a lavatory and drain equipped with S-Trap components (42 and 43). The S-Trap exit section (43) has been modified to meet a claim of this invention. This modification consists of a threaded, removable access plug (49) and a threaded access port (50). Sewer backflow is prevented from coming out of the drain fixture by inserting the Single Drain Inflatable Sewage Backflow Prevention Device (8) into the access port (49) and inflating its' bladder (31).

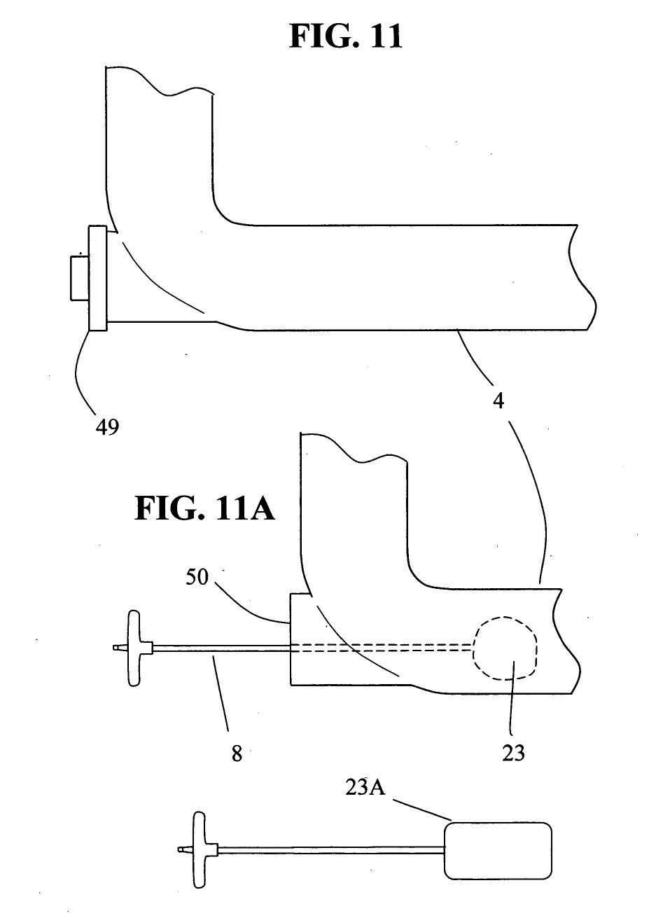

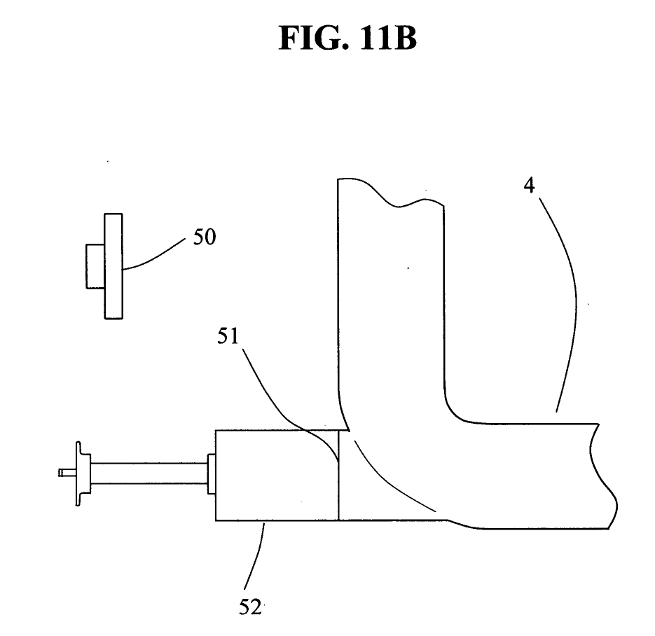

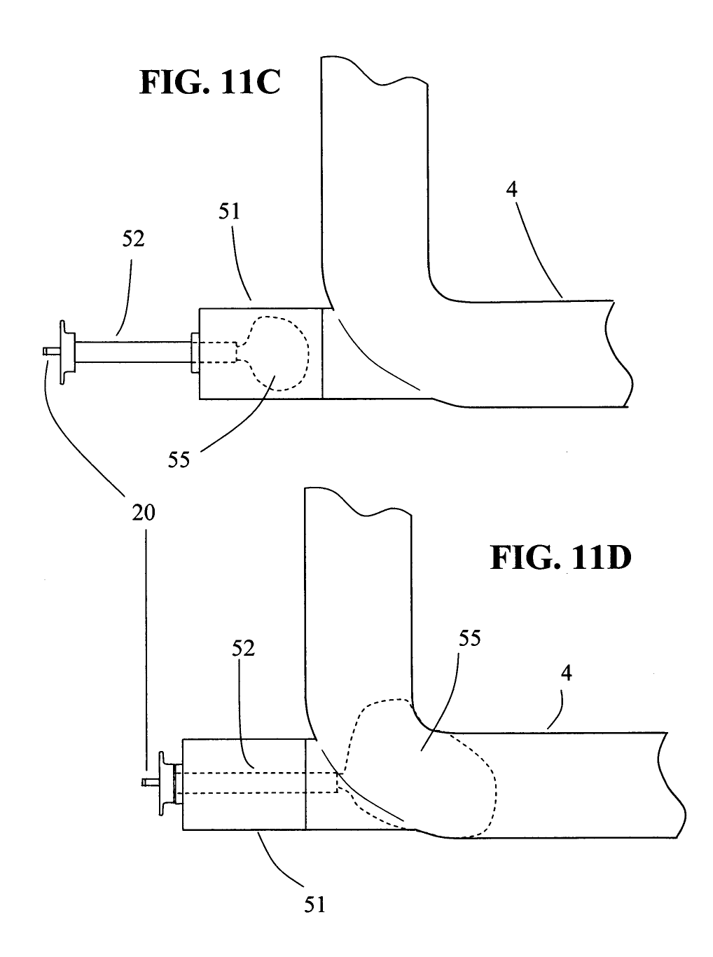

FIG. 11 is a side view of an overhead sewer cleanout trap. This type of trap is typically installed in residences with crawl spaces or basements. A homeowner or plumber can cleanout the sewer by pulling the threaded access cap (49). The Basic Inflatable Sewage Backflow Prevention Device can be used on overhead sewer cleanout traps.

FIG. 11A is a side view of an overhead sewer cleanout trap with the removable access plug (49) removed. This figure illustrates another embodiment of the Basic Inflatable Sewage Backflow Prevention Device. The recommended procedure to insert the Basic

Inflatable Sewage Backflow Prevention Device (8) would be to first run a large volume of tap water thru the drain system prior to removing the threaded access cap (49). This step is recommended in order to clean out the sewer line and sewer lateral line (4) to reduce odor and residue. Once the threaded access cap (49) has been removed, the Basic Inflatable Sewage Backflow Prevention Device (8) can be inserted in the access opening (50). The Basic Inflatable Sewage Backflow Prevention Device bladder (23) can then be inflated to the desired pressure in the same fashion as other embodiments of the Basic Inflatable Sewage Backflow Prevention Device.

Also illustrated is another embodiment of the Basic Inflatable Sewage Backflow Prevention Device. This embodiment employs a thicker bladder (23A) that is cylindrical in shape. The cylindrical shape can be used because this embodiment of the Basic Inflatable Sewage Backflow Prevention Device does not require that the bladder (23A) be maneuvered around and corners or bends prior to inflation.

FIG. 11B is a side view of an overhead cleanout trap that illustrates an additional embodiment of this invention. The Permanently Installed Basic Inflatable Sewage Backflow Prevention Device (52) is designed to be used only as shown with overhead cleanout traps. The assembly (52) is installed by removing the threaded access cap (50) and threading the Permanently Installed Basic Inflatable Sewage Backflow Prevention Device (52) into the access opening (51).

FIG. 11C illustrates the Permanently Installed Basic Inflatable Sewage Backflow Prevention Device (52) in the unused or retracted position.

FIG. 11D illustrates the Permanently Installed Basic Inflatable Sewage Backflow Prevention Device (52) in the extended position. Extension and inflation is accomplished by pushing the Operating Piston (52) forward until it contacts the base unit (51). The bladder (55) is then inflated by adding air to the inflation valve (20).

What is claimed is:

1. A permanently installed, inflatable assembly to block sewage backflow for buildings equipped with a side or elbow mounted sewer line cleanout port comprising:
A threaded body assembly that is inserted into the cleanout plug aperture containing
an inflatable bladder
a pneumatic air valve for inflation,
an inflation status indicator

2. A temporarily installed, inflatable assembly to block sewage backflow thru the sewer lateral line for buildings equipped with a vertical or in-line mounted sewer line cleanout port comprising:
an inflatable bladder
a pneumatic air valve for inflation,
an inflation status indicator
a bladder insertion and removal device

3. A temporarily installed, inflatable assembly to isolate a building sewage system and allow sewer system backflow to exit the cleanout trap for buildings equipped with a vertical or in-line mounted sewer line cleanout port comprising:
an inflatable bladder
a pneumatic air valve for inflation,
an inflation status indicator
a bladder insertion and removal device

4. A temporarily installed, inflatable assembly to bock sewage backflow thru a multitude of household drain types comprising;
an inflatable bladder
a bladder insertion tube
a pneumatic air valve for inflation

5. A permanently installed S-Trap designed to allow direct insertion of an Inflatable Sewage Line Backflow Prevention Device, comprising;
a curved drainpipe with an included access hole
a threaded plug to block the access hole

6. A permanently installed modified P-trap cleanout flange altered to allow direct insertion of an Inflatable Sewage Line Backflow Prevention Device, comprising;
a cleanout flange with an included access hole
a threaded plug to block the access hole
